(19) United States
(12) Patent Application Publication
(10) Pub. No.: US 2007/0258363 A1
(43) Pub. Date: Nov. 8, 2007

(54) Application-aware ATM buffer management method and system

(75) Inventors: Xidong Wu, Livermore, CA (US); Ganesh Krishnamurthi, Danville, CA (US); Haibo Zhang, San Ramon, CA (US)

Correspondence Address: TOLER SCHAFFER, LLP, 8500 BLUFFSTONE COVE, SUITE A201, AUSTIN, TX, 78759, US

(73) Assignee: SBC Knowledge Ventures, LP, Reno, NV (US)

(21) Appl. No.: 11/416,706

(22) Filed: May 3, 2006

(51) Int. Cl. H04L 12/26; H04L 12/403

(52) U.S. Cl. 370/230; 370/449

(57) ABSTRACT

A database stores a plurality of asynchronous transfer mode (ATM) profiles for a plurality of different potential usage patterns for a digital subscriber line (DSL) service. The database associates each of the ATM profiles with a respective buffer size for a network element that is to communicate ATM traffic associated with the DSL service. A data collector collects application layer traffic data for usage of the DSL service by a DSL user. An ATM buffer manager selects an ATM profile, from the plurality of ATM profiles in the database, based on its similarity to the application layer traffic data. The ATM buffer manager allocates to the DSL user a first buffer size in the network element based on the buffer size being associated with the ATM profile in the database.

### FIELD OF THE DISCLOSURE

The present disclosure is generally related to buffer management methods and systems.

### BACKGROUND

Asynchronous Transfer Mode (ATM) is used as a link layer network protocol on top of Asymmetric Digital Subscriber Line (ADSL). An ATM/DS3 signal outputted by an ADSL DSL Multiplexer (DSLAM) is terminated in a router. The router has an ATM buffer which buffers data packets.

Each ADSL user port is mapped to a Permanent Virtual Circuit (PVC). Each PVC is assigned a maximum buffer size. If data packets exceed the maximum buffer size, some of the packets are dropped. A resulting packet loss will cause a lower data throughput and/or a degradation in data quality. Arbitrarily increasing the buffer limit for each PVC results in an insufficient use of the buffer and/or over-subscribing problems.

Queuing and sharing models implemented by routing vendors are challenged when applied to ADSL applications. Traditional stochastic modeling methods, although well-suited backbone ATM trunk switches, are not as well-suited to fit the diverse and individual nature of ADSL users. Each ADSL user may have an entirely different usage pattern, running different applications with their access lines.

### BRIEF DESCRIPTION OF THE DRAWINGS

FIG. 1 is a block diagram of an embodiment of an application-aware intelligent ATM buffer management system,

FIG. 2 is a flow chart of an embodiment of an application-aware intelligent ATM buffer management method;

FIG. 3 a graph that shows TCP throughput of an ADSL line with different ATM buffer sizes; and

FIG. 4 is a block diagram of an illustrative embodiment of a general computer system.

### DETAILED DESCRIPTION OF THE DRAWINGS

Disclosed herein are embodiments of an application-aware method and system of managing an ATM buffer for an ADSL network. The embodiments collect and analyze higher layer (layer 4 and above) information associated with each user's PVC, and allocate an ATM buffer to each user with a respective size based on the higher layer information. The embodiments provide each user a suitable ATM buffer size while mitigating a potential of packet loss and over-subscribing. The embodiments are usable by an Internet services provider (ISP) or another telecommunication services provider which provide asymmetric access connections.

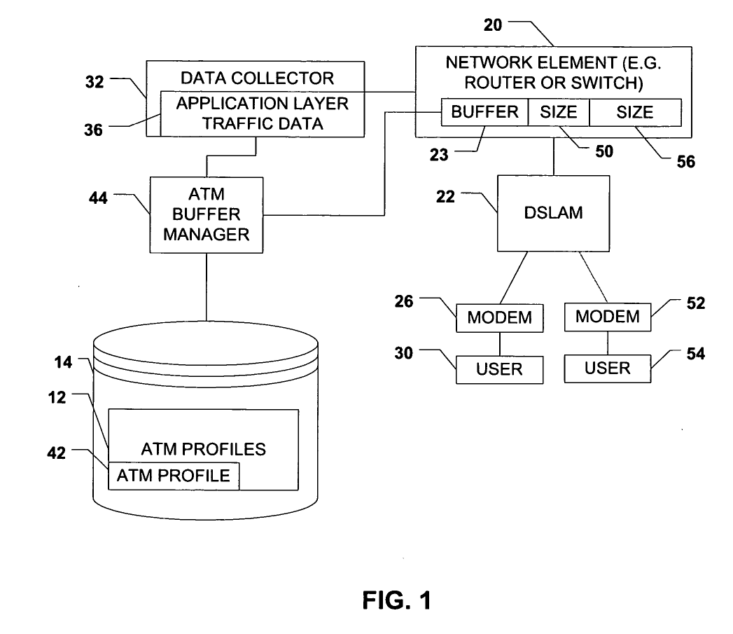

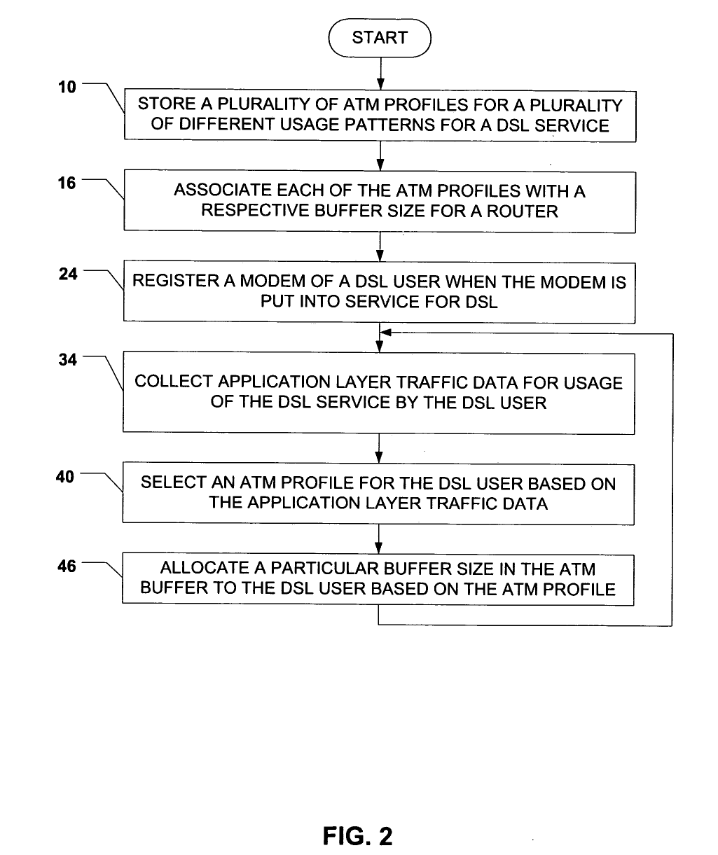

Embodiments are described with reference to FIG. 1, which is a block diagram of an embodiment of an application-aware intelligent ATM buffer management system, and FIG. 2, which is a flow chart of an embodiment of an application-aware intelligent ATM buffer management method.

As indicated by block 10, the method comprises storing a plurality of ATM profiles 12 for a plurality of different potential usage patterns for a DSL service. The ATM profiles 12 are stored in a database 14. In an embodiment, the database 14 associates a data service proportion, a streaming media service proportion and a voice service proportion with the ATM profile. For example, one ATM profile may be for those DSL users whose usage is about 70% data service, 20% streaming media, and 10% voice service.

As indicated by block 16, the method comprises associating each of the ATM profiles 12 with a respective buffer size for a router 20. The database 14 can associate each of the ATM profiles 12 with its respective buffer size. Although described herein for use with the router 20, alternative embodiments can be used to manage ATM buffers in alternative network elements such as switches.

The router 20 is to route or otherwise communicate ATM traffic associated with the DSL service. The DSL service is provided to a plurality of different users via a DSLAM 22 in communication with the router 20. The DSLAM 22 and the router 20 communicate ATM/DS3 signals to provide the DSL service to the different users. The router 20 has an ATM buffer 23 to buffer data packets to avoid packet loss and improve throughput.

Although described with reference to a particular user of the DSL service, the following acts are performed for each of a plurality of different users of the DSL service.

As indicated by block 24, the method comprises registering a modem 26 of a DSL user 30 when the modem 26 is put into service for the DSL service. In an embodiment, the modem 26 registers itself to a data collector 32. The data collector 32 may be embodied by an application data collection server.

As indicated by block 34, the method comprises collecting application layer traffic data 36 for usage of the DSL service by the DSL user 30. In an embodiment, the data collector 32 periodically or otherwise repeatedly pulls the application layer traffic data 36 from the modem 26 of the DSL user 30. The application layer traffic data 36 can represent usage over any period of time. In an embodiment, the application layer traffic data 36 is for at least a week of usage of the DSL service by the DSL user 26.

As indicating by block 40, the method comprises selecting an ATM profile 42 for the DSL user 30 based on the application layer traffic data 36. The ATM profile 42 is selected from the plurality of ATM profiles 12 in the database 14 based on its similarity to the application layer traffic data 36. A buffer size associated with the ATM profile 42 is retrieved from the database 14. In an embodiment, the ATM profile 42 is selected by an ATM buffer manager 44. The ATM buffer manager 44 may be embodied by an ATM buffer management server.

In an embodiment, the ATM buffer manager 44 analyzes the application layer traffic data for each user and selects an optimal or near-optimal ATM profile for the user with an optimal or near-optimal buffer size. For example, the ATM profile 42 may be selected based on its associated data service proportion, streaming media proportion and voice service proportion being most similar (compared to others of the ATM profiles 12) to a data service proportion, streaming media proportion and voice service proportion for the user as exhibited by the application layer traffic data 36. Various similarity measures can be used to determine which ATM profile 42 is most similar to the application layer traffic data 36.

As indicated by block 46, the method comprises allocating a particular buffer size 50 in the ATM buffer 23 to the DSL user 30. The particular buffer size 50 is based on the buffer size associated with the selected ATM profile 42 and retrieved from the database 14. The ATM buffer manager 44 may output a signal to cause the router 20 to allocate the particular buffer size 50 in the ATM buffer 23 to the DSL user 30.

Flow of the method is directed back to block 34 to collect subsequent application layer traffic data for subsequent usage of the DSL service by the DSL user 30. For example, block 34 may be repeated after a period of about a week or more. Based on the subsequent application layer traffic data, either the same ATM profile 42 or a different ATM profile may be selected for the DSL user 30. Either the same buffer size 50 or a different buffer size is allocated in the ATM buffer 23 based on which ATM profile is selected for the DSL user 30.

The herein-disclosed acts are performed for each of a plurality of users of the DSL service. The plurality of users may be different subscribers of the DSL service and/or may be located at different premises. In an embodiment, the ATM buffer manager 44 serves to allocate a respective buffer size in the ATM buffer 23 for each of the users of the DSL service. For example, when a modem 52 of another DSL user 54 is put into service for DSL, the modem 52 registers itself to the data collector 32. The data collector 32 periodically or otherwise repeatedly pulls application layer traffic data from the modem 52 of the DSL user 54. The ATM buffer manager 44 selects an ATM profile for the DSL user 54 based on the application layer traffic data. The ATM profile may be either the same as or different from the ATM profile 42 selected for the DSL user 30. The ATM buffer manager 44 allocates a buffer size 56 in the ATM buffer 23 to the DSL user 54. The particular buffer size 56 is based on the buffer size associated with the selected ATM profile.

By changing the buffer size allocated for the DSL user 30 and/or allocating different buffer sizes for different DSL users, the system adapts to different user applications having different buffer requirements. For example, a limited buffer size can be allocated for an ADSL user who performs a single session application such as file transfer protocol (FTP) or streaming video. A larger buffer size can be allocated to an ADSL user to accommodate the burst nature of his/her Web browsing.

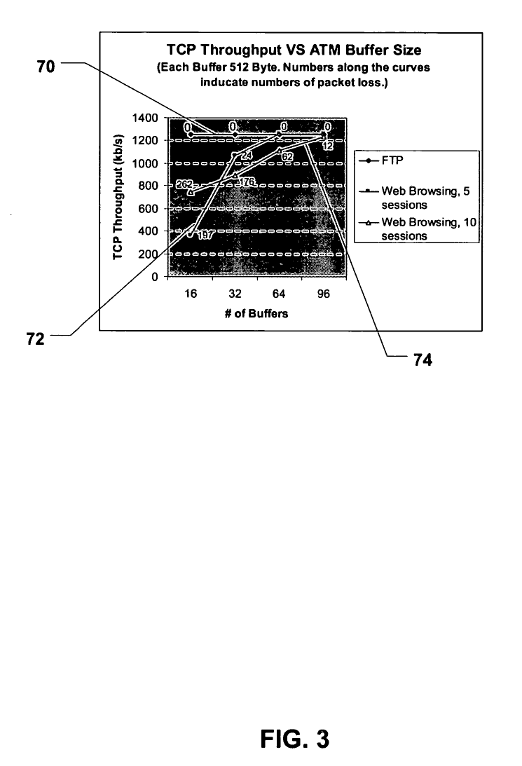

FIG. 3 is a graph that shows TCP throughput of an ADSL line configured to a 1536/384 kb/sec fast channel profile with different ATM buffer sizes. A default buffer size of 16 buffers, wherein each buffer can hold 512 bytes of data, is suitable for FTP as shown in curve 70. Larger buffer sizes are desirable for Web browsing applications because of multiple concurrent TCP connections usually being open. For example, as shown in curve 72, a buffer size of 64 is suitable for Web browsing with five concurrent TCP sessions (e.g. concurrently transporting five 500 kbyte files downstream) to avoid TCP packet loss and have maximum or near-maximum TCP throughput. As shown in curve 74, a buffer size of 96 or more buffers is suitable for Web browsing with ten concurrent TCP sessions (e.g. concurrent transporting ten 500 kbyte files downstream) to avoid TCP packet loss and have maximum or near-maximum TCP throughput.

By analyzing user traffic patterns at the application layer, buffer sizes can be more intelligently allocated. This is in contrast to traditional buffer management systems that have no knowledge of higher-layer user application traffic information. Traditional systems may allocate buffer sizes that are far from optimal on both a per-user basis and a whole-system basis. Traditional systems can under-allocate buffer size for some ADSL users (resulting in packet loss and other degradation in their service) while over-subscribing buffer size for other ADSL users (resulting in wasted ATM buffer space).

In an embodiment, none of the ATM profiles 12 is dedicated to any particular user of the DSL service. Thus, two or more different customers of the DSL service at two or more different customer premises may share the same ATM profile.

The ATM profiles 12 are created based on different potential speed tiers and applications. The different speed tiers may comprise a first tier of less than 384 kbps, a second tier of 384 kbps to 1536 kbps, a third tier of 1536 kbps to 3000 kbps, and a fourth tier of 3000 kbps to 6000 kbps. Associated with each of the ATM profiles 12 may be other tuning parameters (in addition to a transmit buffer size) such as a peak cell rate (PCR), a sustainable cell rate (SCR), a burst tolerance (BT) and a cell delay variance tolerance (CVDT). For single TCP applications, the buffer size and the PCR may be higher than default values for the speed tier. For multiple concurrent TCP applications, the buffer size and the PCR may be higher than those values for single TCP applications for the speed tier, and the PCR may be greater than the SCR. For real-time applications (e.g. streaming video and/or voice over internet protocol), the buffer size may be at or about a default value for the speed tier, the PCR may be equal to SCR, and the CDVT may be higher than a default value for the speed tier. For mixed applications, the parameters can be tuned between pure applications.

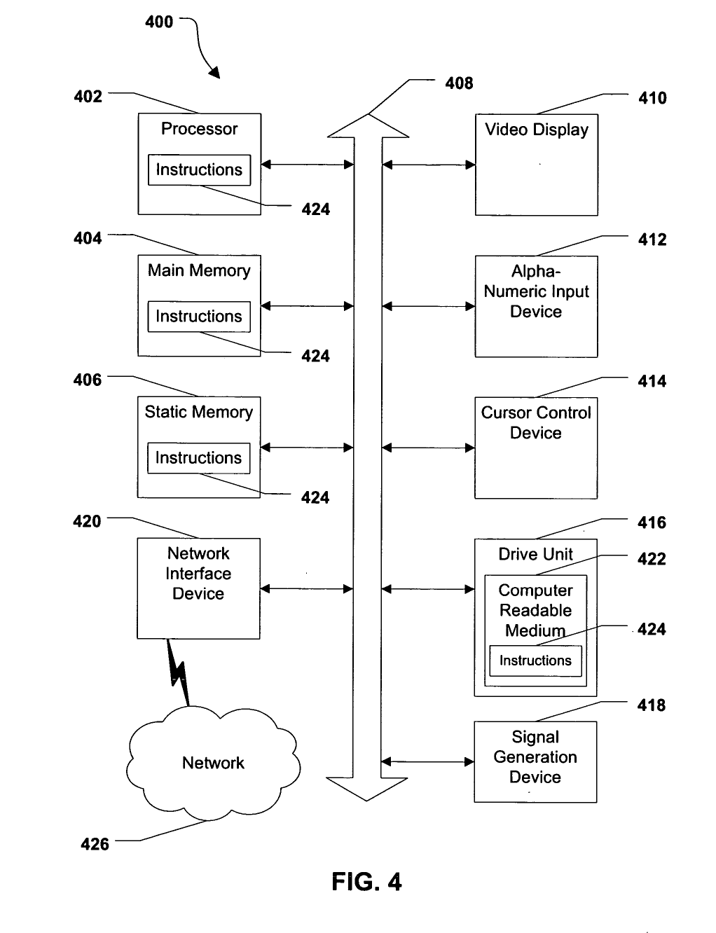

Referring to FIG. 4, an illustrative embodiment of a general computer system is shown and is designated 400. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. Moreover, the computer system 400 can include a main memory 404 and a static memory 406, that can communicate with each other via a bus 408. As shown, the computer system 400 may further include a video display unit 410, such as a liquid crystal display (LCD), an organic light emitting diode (OLED), a flat panel display, a solid state display, or a cathode ray tube (CRT). Additionally, the computer system 400 may include an input device 412, such as a keyboard, and a cursor control device 414, such as a mouse. The computer system 400 can also include a disk drive unit 416, a signal generation device 418, such as a speaker or remote control, and a network interface device 420.

In a particular embodiment, as depicted in FIG. 4, the disk drive unit 416 may include a computer-readable medium 422 in which one or more sets of instructions 424, e.g. software, can be embedded. Further, the instructions 424 may embody one or more of the methods or logic as described herein. In a particular embodiment, the instructions 424 may reside completely, or at least partially, within the main memory 404, the static memory 406, and/or within the processor 402 during execution by the computer system 400. The main memory 404 and the processor 402 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 424 or receives and executes instructions 424 responsive to a propagated signal, so that a device connected to a network 426 can communicate voice, video or data over the network 426. Further, the instructions 424 may be transmitted or received over the network 426 via the network interface device 420.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A system comprising:
a database to store a plurality of asynchronous transfer mode (ATM) profiles for a plurality of different potential usage patterns for a digital subscriber line (DSL) service, and to associate each of the ATM profiles with a respective buffer size for a network element, the network element to communicate ATM traffic associated with the DSL service;
a data collector to collect application layer traffic data for usage of the DSL service by a DSL user; and
an ATM buffer manager to select an ATM profile, from the plurality of ATM profiles in the database, based on its similarity to the application layer traffic data, the ATM buffer manager to allocate to the DSL user a first buffer size in the network element based on the buffer size being associated with the ATM profile in the database.

2. The system of claim 1 wherein the ATM profile is shared by a plurality of different DSL users at a plurality of different customer premises.

3. The system of claim 1 wherein the data collector periodically pulls the application layer traffic data from a modem of the DSL user.

4. The system of claim 1 wherein the application layer traffic data is for at least a week of usage of the DSL service by the DSL user.

5. The system of claim 1 wherein the data collector is to register a modem of the DSL user when the modem is put into service for the DSL service.

6. The system of claim 1 wherein the network element, prior to the ATM buffer manager allocating to the DSL user the first buffer size, has a second buffer size allocated to the DSL user that differs from the first buffer size.

7. The system of claim 1 wherein the database associates a data service proportion, a streaming media proportion and a voice service proportion with the ATM profile.

8. The system of claim 7 wherein the ATM buffer manager selects the ATM profile for the DSL user based on a similarity of the application layer traffic data to the data service proportion, the streaming media proportion and the voice service proportion.

9. A method comprising:
storing, in a database, a plurality of asynchronous transfer mode (ATM) profiles for a plurality of different potential usage patterns for a digital subscriber line (DSL) service;
associating each of the ATM profiles with a respective buffer size for a network element, the network element to communicate ATM traffic associated with the DSL service;
collecting application layer traffic data for usage of the DSL service by a DSL user;
selecting an ATM profile, from the plurality of ATM profiles in the database, based on its similarity to the application layer traffic data; and
allocating to the DSL user a first buffer size in the network element based on the buffer size being associated with the ATM profile in the database.

10. The method of claim 9 wherein the ATM profile is shared by a plurality of different DSL users at a plurality of different customer premises.

11. The method of claim 9 wherein said collecting the application layer traffic data comprises periodically pulling the application layer traffic data from a modem of the DSL user.

12. The method of claim 9 wherein the application layer traffic data is for at least a week of usage of the DSL service by the DSL user.

13. The method of claim 9 further comprising registering a modem of the DSL user when the modem is put into service for the DSL service.

14. The method of claim 9 wherein the network element, prior to said allocating to the DSL user the first buffer size, has a second buffer size allocated to the DSL user that differs from the first buffer size.

15. The method of claim 9 wherein the database associates a data service proportion, a streaming media proportion and a voice service proportion with the ATM profile.

16. The method of claim 15 wherein said selecting the ATM profile is based on a similarity of the application layer traffic data to the data service proportion, the streaming media proportion and the voice service proportion.

17. A system comprising:
a network element to communicate asynchronous transfer mode (ATM) traffic associated with a digital subscriber line (DSL) service;
a database to store a plurality of ATM profiles for a plurality of different potential usage patterns for the DSL service, and to associate each of the ATM profiles with a respective buffer size for the network element;
a data collector to collect first application layer traffic data for usage of the DSL service by a first DSL user, the data collector to collect second application layer traffic data for usage of the DSL service by a second DSL user; and
an ATM buffer manager to select a first ATM profile, from the plurality of ATM profiles in the database, based on its similarity to the first application layer traffic data, the ATM buffer manager to allocate to the first DSL user a first buffer size in the network element based on the first buffer size being associated with the first ATM profile in the database, the ATM buffer manager to select a second ATM profile, from the plurality of ATM profiles in the database, based on its similarity to the second application layer traffic data, the ATM buffer manager to allocate to the second DSL user a second buffer size in the network element based on the second buffer size being associated with the second ATM profile in the database;
wherein the network element, prior to the ATM buffer manager allocating to the first DSL user the first buffer size, has a third buffer size allocated to the first DSL user that differs from the first buffer size.

18. The system of claim 17 wherein none of the plurality of ATM profiles is dedicated to any particular DSL user.

19. The system of claim 17 wherein the first application layer traffic data is for at least a week of usage of the DSL service by the first DSL user.

20. The system of claim 17 wherein the data collector is to register a first modem of the first DSL user when the first modem is put into service for the DSL service, and to register a second modem of the second DSL user when the second modem is put into service for the DSL service, wherein the data collector periodically pulls the first application layer traffic data from the first modem, and periodically pulls the second application layer traffic data from the second modem.

21. A computer-readable medium having computer program code to cause a computer system to:
select an asynchronous transfer mode (ATM) profile, from a database of a plurality of ATM profiles for a plurality of different potential usage patterns for a digital subscriber line (DSL) service, based on its similarity to application layer traffic data for usage of the DSL service by a DSL user;
retrieve a buffer size associated with the ATM profile; and
output a signal to cause a network element to allocate, to the DSL user, the buffer size for communicating ATM traffic associated with the DSL service.
